(19) United States
(12) Patent Application Publication
(10) Pub. No.: US 2017/0024868 A1
(43) Pub. Date: Jan. 26, 2017

(54) HIGH DYNAMIC RANGE IMAGING PIXELS WITH LOGARITHMIC RESPONSE

(71) Applicant: SEMICONDUCTOR COMPONENTS INDUSTRIES, LLC, Phoenix, AZ (US)

(72) Inventor: Nikolai BOCK, San Jose, CA (US)

(73) Assignee: SEMICONDUCTOR COMPONENTS INDUSTRIES, LLC, Phoenix, AZ (US)

(21) Appl. No.: 14/806,249

(22) Filed: Jul. 22, 2015

(51) Int. Cl. G06T 5/00; H04N 5/235; H04N 5/369; H04N 5/355; H04N 5/363; H04N 5/378

(52) U.S. Cl. CPC G06T 5/009; H04N 5/363; H04N 5/378; H04N 5/3698; H04N 5/35581; H04N 5/3559; H04N 5/2357; G06T 2207/10144; G06T 2207/20208

(57) ABSTRACT

An imaging system may include an image sensor having a pixel array. Each pixel in the image array may include a pinned photodiode and an additional photodiode that is configured to operate in photovoltaic mode. The additional photodiode may be operated in photovoltaic mode and may have a logarithmic voltage response to photo-current generated in response to incoming light. The imaging system may mitigate LED flicker by having an extended exposure time for the accurate capture of light sources that oscillate between 80 to 500 Hz. The imaging system may include column readout circuitry that selectively generates an output signal based on voltages corresponding to photo-current generated by either the pinned photodiode or the additional photodiode that are sent to the column readout circuitry during a single exposure and readout period. The selection of the output signal may be dependent on light conditions.

### BACKGROUND

This relates generally to image sensors, and more specifically, to methods and circuitry for operating pixels that include both pinned photodiodes and photovoltaic mode photodiodes for producing high dynamic range (HDR) images.

Image sensors are commonly used in electronic devices such as cellular telephones, cameras, and computers to capture images. Conventional image sensors are fabricated on a semiconductor substrate using complementary metal-oxide-semiconductor (CMOS) technology or charge-coupled device (CCD) technology. The image sensors may include an array of image sensor pixels each of which includes a photodiode and other operational circuitry such as transistors formed in the substrate.

An image sensor has an associated dynamic range, which is expressed as a ratio of the largest and smallest possible luminance values for an image sensor. A conventional image sensor can have a dynamic range of about 60-70 dB. Some applications, such as automobile and surveillance applications, might require a dynamic range of over 100 dB. High dynamic range imaging often refers to techniques for capturing images at dynamic ranges greater than that of the associated image sensor. Techniques such as nonlinear response, multiple exposure, and saturation detection have been proposed for high dynamic range imaging. Each technique has respective advantages and disadvantages. One non-linear response method involves the use of a photodiode in photovoltaic mode.

In photovoltaic mode, a photodiode has the following logarithmic voltage response to photo-generated current:

$${V}_{PD} = - \frac{kT}{q} * ln ( \frac{{I}_{S} + {I}_{p h}}{{I}_{S}} )$$

where k is the Boltzmann constant, T is absolute temperature, q is elementary charge, I_{S} is junction saturation current, and Iₚₕ is photo-current. The drawback to using a photodiode in this mode is that, in photovoltaic mode, the photodiode has poor low light performance because of low photodiode sensitivity in low light conditions in combination with susceptibility to kTC/Johnson noise.

It would therefore be desirable to be able to provide improved image sensors having pixels that include photovoltaic mode photodiodes with high dynamic range and that have improved low light performance.

### BRIEF DESCRIPTION OF THE DRAWINGS

FIG. 1 is a diagram of an illustrative electronic device having an image sensor in accordance with an embodiment of the present invention.

FIG. 2 is a diagram of a conventional image pixel circuit with a single photovoltaic mode photodiode.

FIG. 3 is a diagram of an illustrative image pixel circuit having both a photovoltaic mode photodiode and a pinned photodiode that are coupled to the same floating diffusion node in accordance with an embodiment of the present invention.

FIG. 4 is a timing diagram illustrating the behavior of signals associated with the operation of an image pixel circuit of the type shown in FIG. 3 in accordance with an embodiment of the present invention.

FIG. 5 is a flowchart of illustrative steps that may be performed by an image pixel circuit for capturing image data with a pinned photodiode and with a photovoltaic mode photodiode and for generating an output signal based on the voltage generated by a selected one of the two photodiodes based on a detected light condition in accordance with an embodiment of the present invention.

FIG. 6 is a block diagram of a processor system that may include pixel circuitry of the type shown in FIG. 3 in accordance with an embodiment of the present invention.

### DETAILED DESCRIPTION

Imaging systems having digital camera modules are widely used in electronic devices such as digital cameras, computers, cellular telephones, and other electronic devices. A digital camera module may include one or more image sensors that gather incoming light to capture an image.

In some situations, imaging systems may form a portion of a larger system such as a surveillance system or a safety system for a vehicle (e.g., an automobile, a bus, or any other vehicle). In a vehicle safety system, images captured by the imaging system may be used by the vehicle safety system to determine environmental conditions surrounding the vehicle. As examples, vehicle safety systems may include systems such as a parking assistance system, an automatic or semi-automatic cruise control system, an auto-braking system, a collision avoidance system, a lane keeping system (sometimes referred to as a lane drift avoidance system), etc. In at least some instances, an imaging system may form part of a semi-autonomous or autonomous self-driving vehicle. Such imaging systems may capture images and detect nearby vehicles using those images. If a nearby vehicle is detected in an image, the vehicle safety system may sometimes operate a warning light, a warning alarm, or may activate braking, active steering, or other active collision avoidance measures. A vehicle safety system may use continuously captured images from an imaging system having a digital camera module to help avoid collisions with objects (e.g., other automobiles or other environmental objects), to help avoid unintended drifting (e.g., crossing lane markers) or to otherwise assist in the safe operation of a vehicle during any normal operation mode of the vehicle.

Vehicle safety standards may require that the proper operation of any component of a vehicle safety system (including imaging system components) be verified before, during, and/or after operation of the vehicle. Verification operations for imaging system components may be performed by an imaging system prior to and/or after operation of a vehicle (e.g., upon startup and/or shutdown of the imaging system). In these verification operations, concurrent operation of the imaging system may not be required. However, it may be desirable to continuously monitor the status of imaging system components during operation of the imaging system, particularly in situations in which vehicle safety may be influenced by the quality of imaging data provided by the imaging system. Imaging systems may be provided having this type of on-the-fly (e.g., real-time) verification capability.

Image sensors may include arrays of image pixels. The pixels in the image sensors may include photosensitive elements such as photodiodes that convert the incoming light into electric charge. Image sensors may have any number of pixels (e.g., hundreds or thousands or more). A typical image sensor may, for example, have hundreds, thousands, or millions of pixels (e.g., megapixels). An image sensor may include verification circuitry for verifying the correct operation of the image sensor. For example, in situations in which images captured by the image sensors are used as input to an active control system for a vehicle, verification circuitry in the image sensor may be configured to generate verification image data and compare the verification image data with an expected result so that incorrect image sensor data is not input into the active control system.

In some configurations, verification image data may be compared with a predetermined standard stored in the imaging system, generated by the imaging system during operation, or stored on additional circuitry that is external to the imaging system. The predetermined standard may be a mathematically determined threshold, may sometimes be referred to as a “golden” standard image, may be captured during manufacturing of the imaging system or at another suitable time (e.g., during startup or shutdown of the imaging system), and may include one or more mathematically or experimentally determined ranges to which verification image data may be compared.

In other configurations, verification image data may include a pattern or sequence of data values. The pattern or sequence of data values from the verification image data may be compared with a predetermined pattern or sequence of data values. For example, verification image data may include a frame number that has been digitally encoded into the image. The verification image data may be compared with a known frame number to verify that the frame number encoded into the image matches the known frame number. Other patterns or sequences of data values may be encoded into the image data to be used as verification image data. Digitally encoding the frame count into the image data is sometimes described herein as an example.

Based on the result of the comparison of the verification image data with the predetermined standard or predetermined pattern, an imaging system may be disabled (e.g., if the result is outside the predetermined range or if the result does not match the known frame number) or may continue to operate normally (e.g., if the result is within the predetermined range or if the result matches the known frame number). In some arrangements, the imaging system may remain in operation but an indicator may be presented to users to inform the users that the imaging system needs further inspection and/or repair (e.g., the imaging system may present a “check imaging system” indication when the results of verification operations indicate a potential problem in the operation of the imaging system).

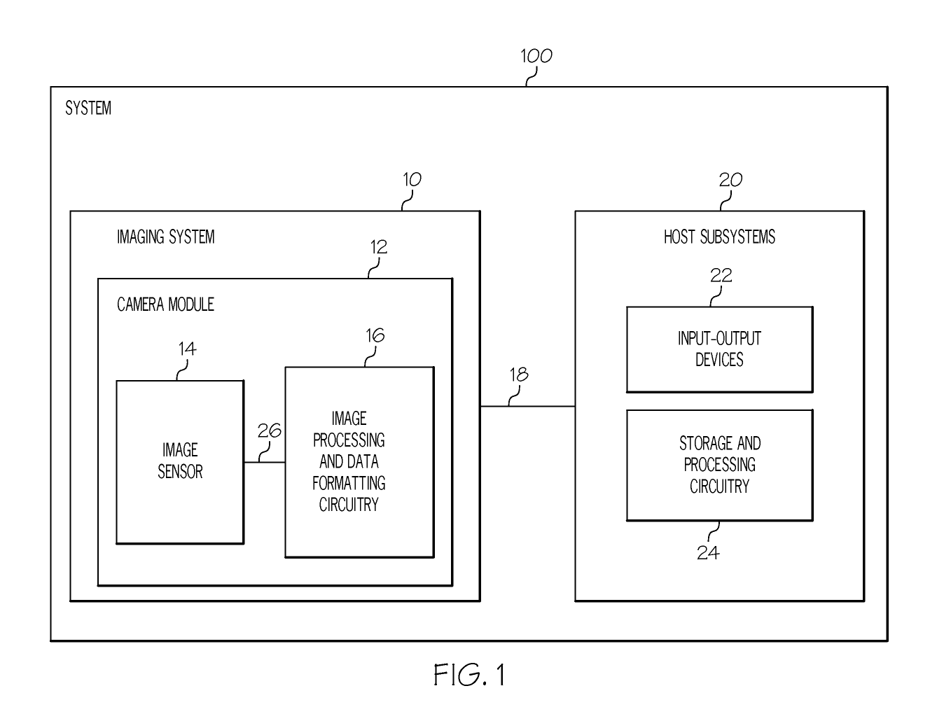

FIG. 1 is a diagram of an illustrative imaging and response system including an imaging system that uses an image sensor to capture images. System 100 of FIG. 1 may be a vehicle safety system (e.g., an active braking system or other vehicle safety system), may be a surveillance system, or may be an electronic device such as a camera, a cellular telephone, a video camera, or other electronic device that captures digital image data.

As shown in FIG. 1, system 100 may include an imaging system such as imaging system 10 and host subsystems such as host subsystem 20. Imaging system 10 may include camera module 12. Camera module 12 may include one or more image sensors 14 and one or more lenses. The lenses in camera module 12 may, as an example, include M*N individual lenses arranged in an M×N array. Individual image sensors 14 may be arranged in a corresponding M×N image sensor array (as an example). The values of M and N may each be equal to or greater than one, may each be equal to or greater than two, may exceed 10, or may have any other suitable values.

Each image sensor in camera module 12 may be identical or there may be different types of image sensors in a given image sensor array integrated circuit. Each image sensor may be a Video Graphics Array (VGA) sensor with a resolution of 480×640 image sensor pixels (as an example). Other arrangements of image sensor pixels may also be used for the image sensors if desired. For example, images sensors with greater than VGA resolution (e.g., high-definition image sensors), less than VGA resolution and/or image sensor arrays in which the image sensors are not all identical may be used.

During image capture operations, each lens may focus light onto an associated image sensor 14. Image sensor 14 may include photosensitive elements (i.e., pixels) that convert the light into digital data. Image sensors may have any number of pixels (e.g., hundreds, thousands, millions, or more). A typical image sensor may, for example, have millions of pixels (e.g., megapixels). As examples, image sensor 14 may include bias circuitry (e.g., source follower load circuits), sample and hold circuitry, correlated double sampling (CDS) circuitry, amplifier circuitry, analog-to-digital (ADC) converter circuitry, data output circuitry, memory (e.g., buffer circuitry), address circuitry, etc.

Still and video image data from camera sensor 14 may be provided to image processing and data formatting circuitry 16 via path 26. Image processing and data formatting circuitry 16 may be used to perform image processing functions such as data formatting, adjusting white balance and exposure, implementing video image stabilization, face detection, etc. Image processing and data formatting circuitry 16 may also be used to compress raw camera image files if desired (e.g., to Joint Photographic Experts Group or JPEG format). In a typical arrangement, which is sometimes referred to as a system on chip (SOC) arrangement, camera sensor 14 and image processing and data formatting circuitry 16 are implemented on a common semiconductor substrate (e.g., a common silicon image sensor integrated circuit die). If desired, camera sensor 14 and image processing circuitry 16 may be formed on separate semiconductor substrates. For example, camera sensor 14 and image processing circuitry 16 may be formed on separate substrates that have been stacked.

Imaging system 10 (e.g., image processing and data formatting circuitry 16) may convey acquired image data to host subsystem 20 over path 18. Host subsystem 20 may include an active control system that delivers control signals for controlling vehicle functions such as braking or steering to external devices. Host subsystem 20 may include processing software for detecting objects in images, detecting motion of objects between image frames, determining distances to objects in images, filtering or otherwise processing images provided by imaging system 10. Host subsystem 20 may include a warning system configured to disable imaging system 10 and/or generate a warning (e.g., a warning light on an automobile dashboard, an audible warning or other warning) in the event that verification image data associated with an image sensor indicates that the image sensor is not functioning properly.

If desired, system 100 may provide a user with numerous high-level functions. In a computer or advanced cellular telephone, for example, a user may be provided with the ability to run user applications. To implement these functions, host subsystem 20 of system 100 may have input-output devices 22 such as keypads, input-output ports, joysticks, and displays and storage and processing circuitry 24. Storage and processing circuitry 24 may include volatile and nonvolatile memory (e.g., random-access memory, flash memory, hard drives, solid state drives, etc.). Storage and processing circuitry 24 may also include microprocessors, microcontrollers, digital signal processors, application specific integrated circuits, etc.

During operation of imaging system 10, camera module 12 may continuously capture and provide image frames to host subsystem 20. During image capture operations, verification circuitry associated with image sensor 14 may be occasionally operated (e.g., following each image frame capture, following every other image frame capture, following every fifth image frame capture, during a portion of an image frame capture, etc.). Images captured when verification circuitry is operated may include verification image data containing verification information. Verification image data may be provided to image processing circuitry 16 and/or storage and processing circuitry 24. Image processing circuitry 16 may be configured to compare the verification image data to a predetermined data set stored on image processing circuitry 16. Following the comparison, image processing circuitry 16 may send status information or other verification information to host subsystem 20.

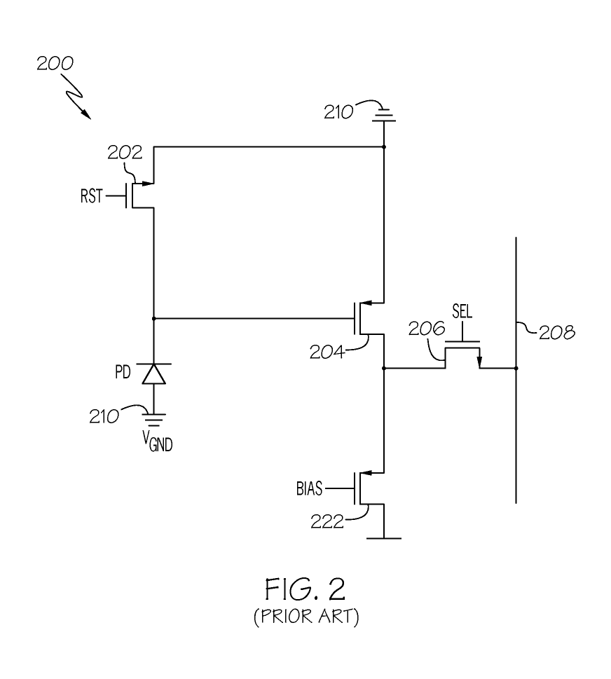

FIG. 2 is a diagram of a conventional image pixel circuit with a single photovoltaic mode photodiode. The image pixel circuit 200 of FIG. 2 includes a photodiode PD, an n-type metal-oxide-semiconductor (NMOS) reset transistor 202, a p-type metal-oxide-semiconductor (PMOS) source-follower transistor 204, an NMOS row select transistor 206, a column output line 208, ground terminals 210, voltage bias terminal 220, and a PMOS bias control transistor 222.

Photodiode PD has an anode that is connected to a ground terminal 210 and has a cathode that is connected to a source terminal of reset transistor 202 and to a gate terminal of source-follower transistor 204. Reset transistor 202 has a gate terminal that receives a reset control signal RST and has a drain terminal that is connected to a ground terminal 210. Source-follower transistor 204 has a source terminal that is connected to ground terminal 210 and has a drain terminal that is connected to a source terminal of row select transistor 206 and to a source terminal of bias control transistor 222. Row select transistor 206 has a gate terminal that receives a row select signal SEL and has a drain terminal that is connected to column output line 208. Bias control transistor 222 has a gate terminal that receives a bias control signal BIAS and has a drain terminal that is connected to voltage bias terminal 220.

Photodiode PD operates in photovoltaic mode. During operation, reset signal RST is asserted to reset the cathode of photodiode PD to ground. Then, when photodiode PD is exposed to light, a negative photovoltaic voltage (corresponding to the light received by photodiode PD) is generated at the cathode of the photodiode. The negative photovoltaic voltage is then converted into a positive voltage by source-follower transistor 204 when bias transistor 222 is active. The positive voltage is then read out to column output line 208 via row select transistor 206 when row select signal SEL is asserted.

There are two drawbacks of this pixel. The first is poor low light performance caused by low photodiode sensitivity in the linear response region of photodiodes operated in photovoltaic mode (e.g., photodiode PD) in combination with kTC noise. The second is the use of PMOS transistors, which may adversely affect pixel fill factor due to N-well spacing design rules. It would therefore be desirable to include additional circuitry within image pixel circuit 200 that improves low light performance of image pixel circuit 200.

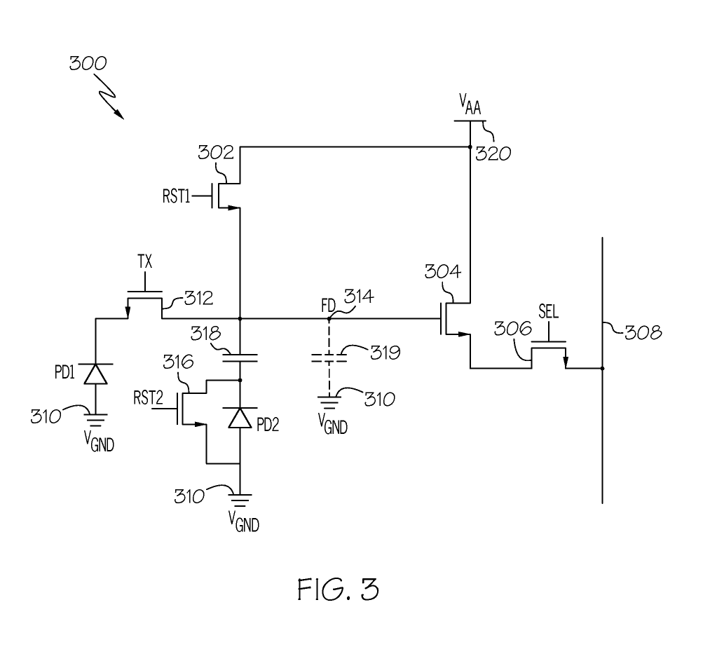

FIG. 3 a diagram of an illustrative image pixel circuit having both a photovoltaic mode photodiode and a pinned photodiode that are coupled to the same floating diffusion node. As shown in FIG. 3, illustrative image pixel circuit 300 may include a pinned photodiode PD1, a photovoltaic mode photodiode PD2, a first NMOS reset transistor 302, an NMOS source-follower transistor 304, an NMOS row select transistor 306, a column output line 308, ground terminals 310 that may be biased to a ground voltage V_{GND}, an NMOS charge transfer transistor 312, a floating diffusion (FD) node 314, a second NMOS reset transistor 316, a coupling capacitor 318, and a reset voltage terminal 320 that may be biased to a reset voltage V_{AA}. Image pixel circuit 300 may be formed on a substrate that is formed of semiconductor material (eg., silicon, silicon carbide, gallium nitride, gallium arsenide, etc.). Image pixel circuit 300 may be part of an image sensor (e.g., image sensor 14 in FIG. 1) that includes an array of image pixels arranged in rows and columns.

Pinned photodiode PD1 may have an anode that is connected to ground terminal 310 and may have a cathode that is connected to floating diffusion node 314 via charge transfer transistor 312. Charge transfer transistor 312 may have a gate terminal that receives a charge transfer control signal TX.

Photovoltaic mode photodiode PD2 may have an anode that is connected to ground terminal 310 and may have a cathode that is connected to floating diffusion node 314 via coupling capacitor 318. The cathode of photodiode PD2 may be connected to ground terminal 310 via reset transistor 316 (i.e., reset transistor 316 may be coupled in parallel with photodiode PD2). Reset transistor 316 may have a gate terminal that receives a reset control signal RST2.

A pinned photodiode (e.g., pinned photodiode PD1) operates by accumulating charge when exposed to light during an exposure period before transferring accumulated charge elsewhere (e.g., floating diffusion node 314). In contrast, a photodiode that operates in photovoltaic mode (e.g., photovoltaic mode photodiode PD2) operates by generating current when exposed to light, which leads to a change in voltage potential at the cathode of the photodiode (e.g., at floating diffusion node 314) as light levels change. It should be noted that a photovoltaic mode photodiode provides an instantaneous electrical response (e.g., instantaneous change in voltage) to changes in light level, whereas a pinned photodiode provides an accumulated electrical response to light levels over a period of time. As an example, as light level decreases, the instantaneous voltage output of a photodiode in photovoltaic mode might decrease as a result, whereas the accumulated charge of a pinned photodiode in similar conditions would still increase, but would do so at a slower rate.

Source-follower transistor 304 may have a gate terminal that is connected to floating diffusion node 314, may have a drain terminal that is connected to column output line 308 via row select transistor 306, and may have a source terminal that is connected to reset voltage terminal 320. Row select transistor 306 may have a gate terminal that receives a row select control signal SEL.

Reset voltage terminal 320 may be connected to floating diffusion node 314 via reset transistor 302. Reset transistor 302 may have a gate terminal that receives a reset control signal RST1.

Floating diffusion node 314 may be coupled to ground terminal 310 via parasitic capacitance 319. Parasitic capacitance 319 and coupling capacitor 318 form a capacitive divider.

Image pixel circuit 300 may be connected to column readout circuitry (not shown) via column output line 308. The column readout circuitry may generate an output signal based on voltage generated by photodiode PD1 or voltage generated by photodiode PD2 depending on light conditions.

Image pixel circuit 300 may operate in low light conditions using pinned photodiode PD1 and may otherwise perform high dynamic range imaging using photovoltaic mode photodiode PD2 without the need for exposure control. Image pixel circuit 300 may have an extended exposure time for the accurate capture of light sources that oscillate between 80 to 500 Hz. This extended exposure time may be beneficial for mitigating the effects of LED flicker. The inclusion of coupling capacitor 318 may allow for only NMOS transistors to be used in image pixel circuit 300, which may improve pixel fill factor.

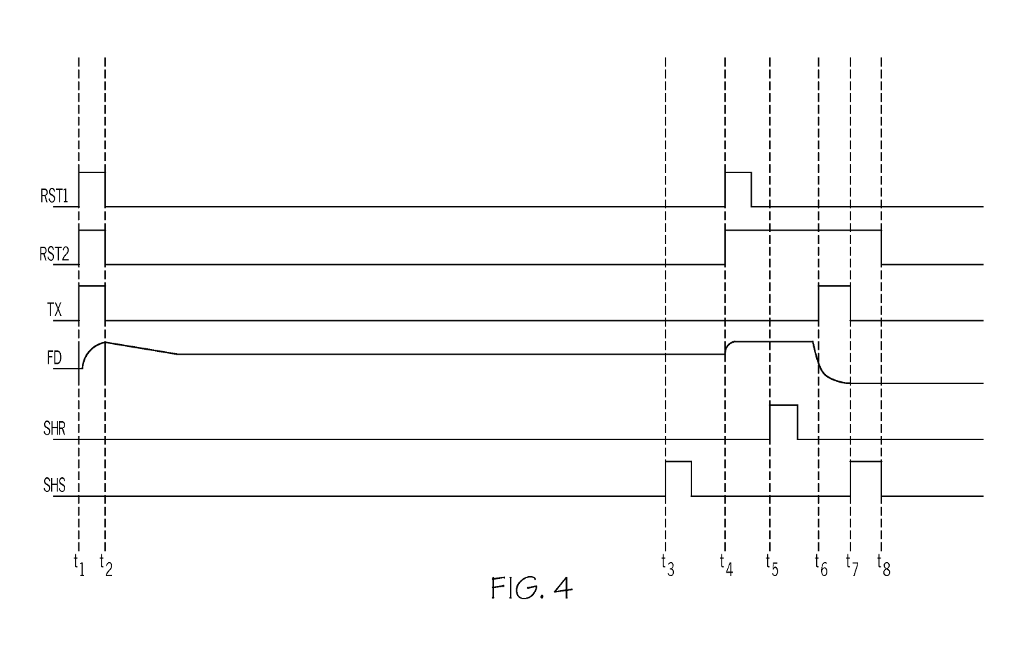

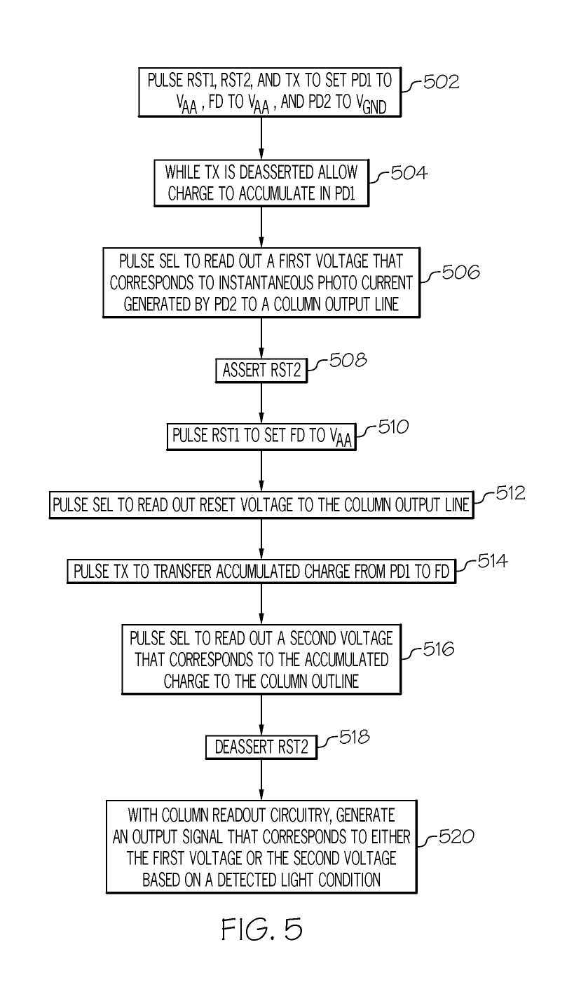

FIG. 4 is an illustrative timing diagram illustrating signal levels associated with the operation of an image pixel circuit of the type shown in FIG. 3 in accordance with an embodiment of the present invention. The timing diagram in FIG. 4 corresponds to the illustrative steps of the flow chart in FIG. 5. Signal FD corresponds to the voltage at floating diffusion node 314. Signal SHR corresponds to pulsing signal SEL to sample a reset voltage. Signal SHS corresponds to pulsing signal SEL to sample a photodiode voltage corresponding to either photodiode PD1 or photodiode PD2.

As shown in step 502, from times t1 to t2, signal RST1, signal RST2 and signal TX may be asserted to activate charge transfer transistor 312, reset transistor 302, and reset transistor 316 in order to set floating diffusion node 314 and the cathode of photodiode PD1 to voltage V_{AA} and to set the cathode of photodiode PD2 to voltage V_{GND}.

Incoming light may be detected by a photosensitive elements such as photodiode PD1 or photodiode PD2. As shown in step 504, from times t2 to t3, signal FD may reach steady state at a first voltage corresponding to the instantaneous voltage generated based on the amount of light received by photodiode PD2 while charge accumulates in photodiode PD1 as a result of incident light received by photodiode PD1. As shown in step 506, from times t3 to t4, signal SHS (corresponding to signal SEL) may be asserted to activate row select transistor 306 and the first voltage corresponding to photodiode PD2 may be sampled from floating diffusion node 314 to column readout circuitry via column readout line 308.

As shown in step 508, from times t4 to t8, RST2 may be asserted to activate reset transistor 316 in order to hold the cathode of photodiode PD2 at voltage V_{GND}. As shown in step 510, from times t4 to t5, signal RST1 may be asserted to activate reset transistor 302 in order to set floating diffusion node 314 to voltage V_{AA}. As shown in step 512, from times t5 to t6, signal SHR (corresponding to signal SEL) may be asserted to activate row select transistor 306, and a reset voltage may be sampled from floating diffusion node 314 to column readout circuitry via column readout line 308.

From times t2 to t6, photo-generated charge may accumulate in photodiode PD1. As shown in step 514, from times t6 to t7, signal TX may be asserted to activate charge transfer transistor 312 in order to dump charge that has accumulated in photodiode PD1 to floating diffusion node 314, resulting in floating diffusion node 314 being set to a second voltage that corresponds to the charge accumulated in photodiode PD1. As shown in step 516, from times t7 to t8, signal SHS (corresponding to signal SEL) may be asserted to activate row select transistor 306 and the second voltage corresponding to the charge accumulated in photodiode PD1 may be sampled from floating diffusion node 314 to column readout circuitry via column readout line 308. As shown in step 518, at time t8, signal RST2 may be deasserted.

As shown in step 520, once column readout circuitry has received the reset voltage, the first voltage corresponding to photodiode PD2, and the second voltage corresponding to photodiode PD1, the column readout circuitry may generate an output signal that corresponds to either the first voltage or the second voltage based on a detected light condition. In low light conditions (e.g., when light levels are below a predetermined threshold), the second voltage produced by pinned photodiode PD1 may be the basis for the output signal. In other light conditions (e.g., when light levels are above the predetermined threshold), the first voltage produced by photovoltaic mode photodiode PD2 may be the basis for the output signal in order to achieve a higher dynamic range compared to that which can be acquired using a pinned photodiode such as photodiode PD1.

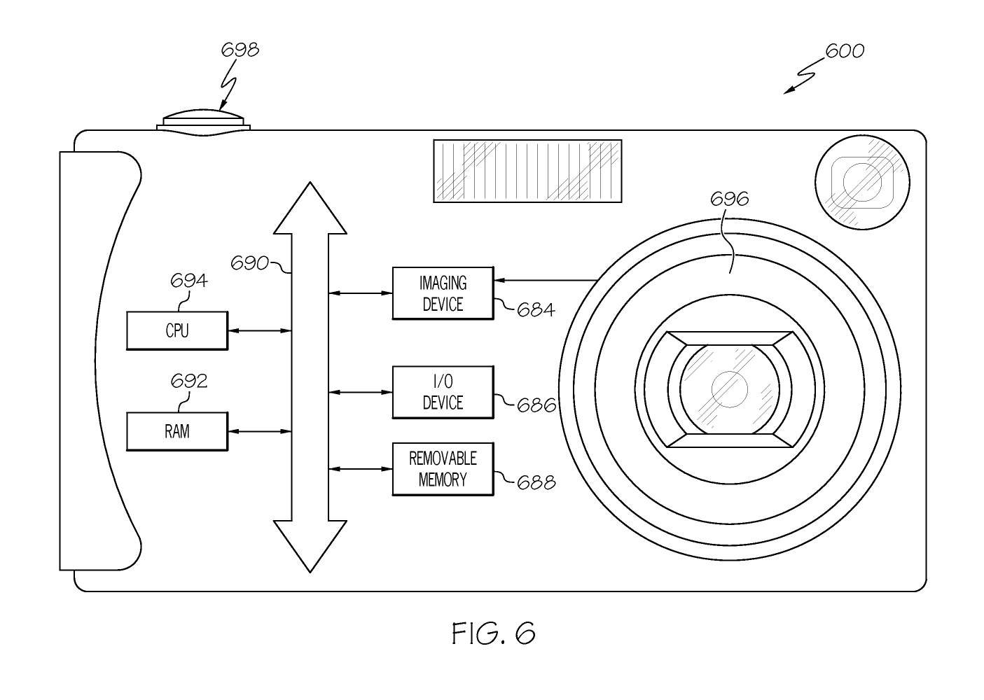

FIG. 6 is a block diagram of a processor system employing the image pixel circuit of FIG. 3 in accordance with an embodiment. Device 684 may comprise the elements of device 10 (FIG. 1) or any relevant subset of the elements. Processor system 600 is exemplary of a system having digital circuits that could include imaging device 684. Without being limiting, such a system could include a computer system, still or video camera system, scanner, machine vision, vehicle navigation, video phone, surveillance system, auto focus system, star tracker system, motion detection system, image stabilization system, and other systems employing an imaging device.

Processor system 600, which may be a digital still or video camera system, may include a lens or multiple lenses indicated by lens 696 for focusing an image onto an image sensor, image sensor array, or multiple image sensor arrays such as image sensor 16 (FIG. 1) when shutter release button 698 is pressed. Processor system 600 may include a central processing unit such as central processing unit (CPU) 694. CPU 694 may be a microprocessor that controls camera functions and one or more image flow functions and communicates with one or more input/output (I/O) devices 686 over a bus such as bus 690. Imaging device 684 may also communicate with CPU 694 over bus 690. System 600 may include random access memory (RAM) 692 and removable memory 688. Removable memory 688 may include flash memory that communicates with CPU 694 over bus 690. Imaging device 684 may be combined with CPU 694, with or without memory storage, on a single integrated circuit or on a different chip. Although bus 690 is illustrated as a single bus, it may be one or more buses or bridges or other communication paths used to interconnect the system components.

Various embodiments have been described illustrating an imaging system (e.g., system 100 of FIG. 1) including an imaging system and host subsystems. An imaging system may include one or more image sensors. Each image sensor may include an array of image sensor pixels. Each image sensor pixel may include one or more photosensitive elements configured to convert incoming light into electric charge.

Each image sensor may include an array of pixels arranged in rows and columns. Each image sensor pixel may include a floating diffusion node, a first photosensitive element having a linear photocurrent response, and a second photosensitive element having a non-linear photocurrent response.

According to one example, the first photosensitive element may be a pinned photodiode and the non-linear response of the second photosensitive element may be a logarithmic response. A charge transfer transistor may be coupled between the first photosensitive element and the floating diffusion node. A coupling capacitor may be coupled between the second photosensitive element and the floating diffusion node. A first reset transistor may be coupled between a power supply line and the floating diffusion node. A second reset transistor may be coupled between first and second terminals of the second photosensitive element. The floating diffusion node may be coupled to the gate terminal of an n-channel source-follower transistor. The n-channel source follower transistor may have a drain terminal that is coupled to the power supply line and a source terminal that is coupled to a column output line. A row select transistor may be coupled between the source terminal of the n-channel source-follower transistor and the column output line.

According to another example, each image sensor pixel may be operated in first and second modes. In the first mode, a first output signal may be generated by column output circuitry in response to a first detected light condition based on charge accumulated in a first photodiode in the image sensor pixel. In the second mode, a second output signal may be generated by the column output circuitry in response to a second detected light condition that is different from the first detected light condition based on an instantaneous voltage across a second photodiode in the image sensor pixel. The first detected light condition may occur when light level is less than a predetermined threshold. The second detected light condition may occur when light level is greater than a predetermined threshold. During a reset period, the first photodiode may be set to a reset voltage, the second photodiode may be set to a ground voltage, and a floating diffusion region may be set to the reset voltage. During an exposure period, charge may be allowed to accumulate in the first photodiode while the floating diffusion region is held at a first voltage that corresponds to photo-current generated by the second photodiode. The first voltage may be read out from the floating diffusion region to a column output line. After reading out the first voltage, the floating diffusion region may be set to the reset voltage and the second photodiode may be set to the ground voltage. While the second photodiode is held at the ground voltage, the reset voltage may be read out from the floating diffusion region to the column output line. After reading out the reset voltage and while the second photodiode is held at the ground voltage, accumulated charge may be transferred from the first photodiode to the floating diffusion region. While the second photodiode is held at the ground voltage, a second voltage that corresponds to the accumulated charge may be read out from the floating diffusion region to the column output line.

According to another example, the imaging system may be configured to have an extended exposure time for the accurate capture of light sources that oscillate between 80 to 500 Hz. Each imaging pixel may include a pinned photodiode and an additional photodiode. The additional photodiode may be a different type of photodiode than the pinned photodiode. The additional photodiode may be configured to operate in photovoltaic mode. A reset transistor may be coupled in parallel with the additional photodiode.

The foregoing is merely illustrative of the principles of this invention and various modifications can be made by those skilled in the art without departing from the scope and spirit of the invention. The foregoing embodiments may be implemented individually or in any combination.

What is claimed is:

1. An image sensor pixel, comprising:
a floating diffusion node;
a first photosensitive element having a linear photocurrent response; and
a second photosensitive element having a non-linear photocurrent response.

2. The image sensor pixel defined in claim 1, wherein the first photosensitive element comprises a pinned photodiode, and wherein the non-linear response of the second photosensitive element comprises a logarithmic response.

3. The image sensor pixel defined in claim 1, further comprising:
a charge transfer transistor that is coupled between the first photosensitive element and the floating diffusion node; and
a coupling capacitor that is coupled between the second photosensitive element and the floating diffusion node.

4. The image sensor pixel defined in claim 3, wherein the second photosensitive element comprises first and second terminals, and wherein the image sensor pixel further comprises:
a first reset transistor that is coupled between the power supply line and the floating diffusion node; and
a second reset transistor coupled between the first and second terminals of the second photosensitive element.

5. The image sensor pixel defined in claim 4, further comprising:
a power supply line; and
an n-channel source-follower transistor having a gate terminal that is coupled to the floating diffusion node, a drain terminal that is coupled to the power supply line, and a source terminal that is coupled to a column output line.

6. The image sensor pixel defined in claim 5, further comprising:
a row select transistor that is coupled between the source terminal of the n-channel source-follower transistor and the column output line.

7. A method of operating an image pixel in first and second modes, comprising:
placing the image pixel in a first mode to generate a first output signal in response to a first detected light condition, wherein the first output signal is generated based on charge accumulated in a first photodiode in the image pixel; and
placing the image pixel in a second mode to generate a second output signal in response to a second detected light condition that is different than the first detected light condition, wherein the second output signal is generated based on an instantaneous voltage across a second photodiode in the image pixel.

8. The method defined in claim 7, wherein the image pixel further includes a floating diffusion region that is coupled to the first and second photodiodes, the method further comprising:
during a reset period, setting the first photodiode to a reset voltage, setting the second photodiode to a ground voltage, and setting the floating diffusion region to the reset voltage.

9. The method defined in claim 8, further comprising:
during an exposure period, allowing charge to accumulate in the first photodiode while the floating diffusion region is held at a first voltage that corresponds to photo-current generated by the second photodiode.

10. The method defined in claim 9, further comprising:
reading out the first voltage from the floating diffusion region to a column output line.

11. The method defined in claim 10, further comprising:
after reading out the first voltage, setting the floating diffusion region to the reset voltage and setting the second photodiode to the ground voltage.

12. The method defined in claim 11, further comprising:
while the second photodiode is held at the ground voltage, reading out the reset voltage from the floating diffusion region to the column output line.

13. The method defined in claim 12, further comprising:
after reading out the reset voltage and while the second photodiode is held at the ground voltage, transferring accumulated charge from the first photodiode to the floating diffusion region; and
while the second photodiode is held at the ground voltage, reading out a second voltage that corresponds to the accumulated charge from the floating diffusion region to the column output line.

14. The method defined in claim 7, wherein the first output signal is generated by column output circuitry when a light condition is detected that is less than a predetermined threshold, and the second output signal is generated by the column output circuitry when a light condition is detected that is greater than the predetermined threshold.

15. A system, comprising:
a central processing unit;
memory;
a lens;
input-output circuitry; and
an imaging device, wherein the imaging device comprises:
an array of pixels arranged in rows and columns, wherein each pixel comprises:
a floating diffusion node;
a pinned photodiode that is coupled to the floating diffusion node; and
an additional photodiode that is configured to operate in photovoltaic mode and that is coupled to the floating diffusion node.

16. The system defined in claim 15, wherein the imaging device is configured to have an extended exposure time for the accurate capture of light sources that oscillate between 80 Hz to 500 Hz.

17. The system defined in claim 15, wherein the additional photodiode and the pinned photodiode are different types of photodiodes.

18. The system defined in claim 17, wherein the imaging device further comprises:
column readout circuitry configured to selectively generate an output signal that corresponds to one of the group consisting of: charge accumulated by the pinned photodiode and voltage generated by the additional photodiode.

19. The system defined in claim 15, further comprising:
a charge transfer transistor coupled between the pinned photodiode and the floating diffusion node; and
an capacitor that is coupled between the additional photodiode and the floating diffusion node.

20. The system defined in claim 15, wherein each pixel further comprises:
a reset transistor coupled in parallel with the additional photodiode.
